(19) United States
(12) Patent Application Publication
(10) Pub. No.: US 2005/0220240 A1
(43) Pub. Date: Oct. 6, 2005

(54) Clock synchroniser and clock and data recovery apparatus and method

(76) Inventor: Paul Lesso, Edinburgh (GB)

Correspondence Address: DICKSTEIN SHAPIRO MORIN & OSHINSKY LLP, 2101 L Street, NW, Washington, DC, 20037, US

(21) Appl. No.: 10/900,347

(22) Filed: Jul. 28, 2004

(30) Foreign Application Priority Data
Apr. 6, 2004 (GB) 0407837.4

(51) Int. Cl. H04L 7/00

(52) U.S. Cl. 375/372

(57) ABSTRACT

A clock synchroniser, and clock and data recovery apparatus incorporating the clock synchroniser, are described, together with corresponding clock synchronisation methods. The clock synchroniser incorporates an elastic buffer. A received clock signal is used to clock data into the buffer, and a locally generated clock is used to clock data out of the buffer. The local clock is synthesised using a PLL, and a fill-level signal from the elastic buffer is used to control to local clock frequency to maintain a desired average quantity of data in the buffer, thereby achieving synchronisation of the received and local clocks. In preferred embodiments the fill-level signal is used to control a variable divider in the feedback path of the PLL, which is supplied with a highly stable reference signal. A synchronised, and low-jitter local clock is thus produced. Preferably, the elastic buffer employs counters of relatively wide word width, and a storage array of much reduced depth, read and write pointers being provided by just a few of the least significant bits of the words.

### FIELD OF THE INVENTION

The present invention relates to clock synchronisers and to clock and data recovery apparatus and methods. Particular embodiments are concerned with methods and circuits for recovering a low jitter clock and data from jittered data (e.g. a jittery data stream).

### BACKGROUND TO THE INVENTION

FIG. 1 shows a data link comprising two systems each clocked by a respective PLL. The transmitter transmits data at a given rate and the receiver clocks the data in using its local clock. However the two clock frequencies may not be exactly the same, either short-term or long-term.

Short-term variations in frequency will arise in each clock from thermal noise or external interference, and can be considered as jitter in the respective clocks. Additional jitter in the data stream may be introduced by inter-symbol interference due to the finite bandwidth of the transmission channel or by crosstalk between adjacent cables.

For general data links, increasing amounts of jitter may only cause problems if they lead to unacceptable data error rates in the received data. However for audio data links, even small amounts of jitter may be important, since the digital audio signal will eventually be reproduced as an analogue waveform by a digital-analogue converter (DAC). For high quality reproduction of the digital audio a significant amount of jitter will impair the performance.

Errors in the timing signal at the DAC are called aperture jitter. For a DAC with sinusoidal jitter on the sample clock the maximum SNR achievable due to aperture jitter is
SNR=−20log(σⱼ, ωⱼ)
where ωⱼ is the frequency of the jitter and σⱼ is the root mean square (r.m.s) value of the jitter, Hence for a 16 kHz sinusoidal jitter with a r.m.s. value of 1 ns the maximum SNR due to aperture jitter is 80 dB which is not acceptable for Hi-Fi applications. For many audio data signals jitter over ins r.m.s. can be seen. The specification for S/PDIF digital audio data links allows incoming low-frequency (<5 Hz) sinusoidal jitter of 10UI (several microseconds) amplitude.

Long-term, both crystals will have a frequency error (possibly 500 ppm) and there may also be an error in the frequency generated by the PLL at either end. For example both PLLs may be fractional-N PLLs with the same input frequency but with subtly different divider ratios, whose output frequencies both meet the specified minimum and maximum frequency range, but are in fact slightly different. If the transmitter clock is faster than the receiver clock, data will occasionally be lost: if the receiver clock is faster than the transmitter clock occasional bits will be sampled and clocked out twice. Even a few ppm difference on a 12 MHz data stream could give missing bits several times a second, which would be completely unacceptable for both digital audio data or indeed more general data streams.

One known method attempting to solve the problem of loss of data in data links due to short-term variations in clock timing has involved the use of an elastic buffer (EB). Elastic buffers are a well known type of FIFO data storage which read in data using one clock and write out data using another clock, in the past typically holding many samples of data to ensure that when the clocks drift past each other no data is lost, at least until the clock slippage exceeds the depth of the buffer.

U.S. Pat. No. 6,594,329 describes an elastic buffer that is sitting between two distinct clock domains. However, in this implementation the elastic buffer is used merely to absorb the short- and medium-term jitter and no effort is made to synchronise the local clock to the remote clock, i.e. no measures are taken to ensure the respective data rates are the same long term, to avoid loss of data. For some protocols where IDLE data can be sent this is acceptable, provided the data slips are controlled to occur during IDLE data, not real data. However for systems with no IDLE data this system will results in corrupted and/or lost data. Thus, the circuits disclosed in U.S. Pat. No. 6,594,329 may be used in asynchronous data systems, but cannot be used in synchronous systems, such as audio systems, where input and output sample rates do have to be equal long-term.

Elastic buffers typically provide a fill-level signal that is indicative of the amount of stored data in them at a particular time. Circuits are known in which this fill level signal has been used to change the speed of a voltage-controlled oscillator (VCO) clocking data out of the EB. The speed has been changed in bands to ensure no data is lost. In other words, the speed of the VCO is varied in steps as a function of the fill level of the buffer. If the buffer is getting too full the VCO output frequency is increased so as to reduce the amount of stored data, and so prevent buffer overflow, and if the buffer is getting too empty the VCO is slowed down. However, the consequent large steps in the VCO output frequency makes these types of circuits unsuitable for synchronous systems.

Other known circuits have used a filtered version of the EB fill level to drive the VCO directly via a digital-analogue converter (DAC). However in such systems the quality of the clock produced depends heavily on the design of the DAC. In order to have a good frequency resolution, the DAC needs to have a large number of ENOBS (effective number of bits). This increases the complexity and cost of the system, and there still remains the problem of jitter on the “local clock” generated by the VCO

U.S. Pat. No. 6,606,360 improves on the circuits disclosed in U.S. Pat. No. 6,594,329 by having a multi strand clock from which multiple phases can be chosen from to ensure that the local clock is running isochronously to the remote clock. However for a non-rational frequency difference the phase will be constantly adjusting to keep track and this will result in a jittery local clock. No data loss will occur but the recovered clock will not be suitable for use with a DAC.

Traditionally clock synchronisers have been implemented by using an analogue phase locked loops (PLL), with large off-chip components to attenuate the jitter on the reference clock.

In such a system, the receiving PLL will pass jitter unattenuated up to its loop bandwidth. Conversely the noise from the VCO inside the PLL will be attenuated only up to the loop bandwidth. There is a trade-off involved in setting the loop bandwidth, between minimising the jitter passed by the PLL and suppressing the noise-induced jitter from the VCO. Also as the loop filter bandwidth is reduced the loop filter components become much larger to achieve the long time constant needed. When the loop filter components become too large they must be realised as off chip components. These off-chip components increase the cost and physical size of the design. They can also degrade the performance unless great care is exercised. ‘Ground bounce’, or momentary differences between the ground off- and on-chip, is hard to reduce in a practical IC package design, and can possibly even introduce more jitter than the loop filter is attenuating from the remote clock. Also if the bandwidth of the receiving PLL is too small, it may be unable to respond quickly enough to track large short-term jitter well enough to recover the data properly.

In practice two PLLs may be needed—one high-bandwidth to track the incoming clock and recover the data, and another low-bandwidth PLL used to reduce the amount of jitter on the recovered clock. The low-bandwidth loop still receives a signal with a large amount of jitter from the high-bandwidth loop, so may occasionally lose lock unless design compromises are made with its performance.

In summary, there is thus a need for a system that can generate a clock that is the same frequency as an incoming data stream, but with substantially less jitter than that of the data clock as extracted from the data stream. Preferably this should be low-cost, require a minimum of external components.

### SUMMARY OF THE INVENTION

According to a first aspect of the present invention there is provided a clock synchroniser for generating a local clock signal synchronised to a received clock signal (i.e. the local and received clocks have the same average frequency over a length of time), comprising:
a reference oscillator arranged to provide a reference signal having a reference frequency;
a synthesiser circuit arranged to generate a local clock signal from the reference signal;
an elastic buffer comprising data storage adapted to store data; and
a control link (connection, path, circuit) linking the elastic buffer to the synthesiser circuit,
wherein the synthesiser circuit comprises a phase-locked-loop circuit comprising
a controlled oscillator arranged to receive an oscillator control signal and to generate, at a controlled oscillator output, an oscillatory output signal having a frequency dependent on the oscillator control signal and which determines the local clock signal frequency,
a phase detector, having a first input arranged to receive the reference signal,
a feedback path from the controlled oscillator output to the phase detector and providing an oscillatory signal to a second input of the phase detector, the phase detector generating an output signal indicative of a phase difference between the reference signal at said first input and the oscillatory signal at said second input, and
an oscillator control signal generating circuit arranged to receive the output signal of the phase detector and to generate said oscillator control signal according to the phase detector output signal,
and wherein the elastic buffer has a data input for receiving data, a first clock input for receiving a received clock signal, a data output for outputting data, and a second clock input arranged to receive the local clock signal from the synthesiser circuit,
the elastic buffer being responsive to a received clock signal at the first clock input to clock data provided to the data input into the data storage (at a received clock rate), and being responsive to the local clock signal at the second clock input to clock data out of the data storage (at a local clock rate),
the elastic buffer being further adapted to output a digital fill-level signal indicative of the quantity of data stored in the data storage, and
the control link being arranged to receive the digital fill-level signal and to provide a frequency control signal to the phase-locked-loop circuit to control the frequency of the oscillatory output signal according to the digital fill-level signal so as to control the local clock frequency to maintain a desired average quantity of data in the data storage.

This results in synchronisation of the received and local clocks. The rate at which data is clocked into the buffer is synchronised with the rate at which data is clocked out in the sense that, over a period of time, the average rates are equal. In other words, the local clock rate is adjusted/controlled according to the fill-level signal from the elastic buffer, using a feedback loop, to maintain the average quantity of data stored in the elastic buffer at a substantially constant value (or within predetermined limits) such that the average data-in rate matches the average data-out rate. If the buffer is too full (i.e. if the average quantity of stored data over some time period is above a predetermined value or threshold), the PLL is controlled to speed up (i.e. the local clock rate is increased) to bring the average down, and if the buffer is too empty (i.e. if the average quantity of stored data over some time period is below a predetermined value or threshold), the PLL is controlled to slow down (the local clock rate is decreased) to bring the average up. Thus, the PLL is controlled to maintain a substantially constant desired average value of fill level, and by doing this, the local clock signal is synchronised to the received clock signal. Even though the received clock rate may vary with time, and may be jittery, the average amount of data stored in the buffer is maintained substantially constant.

Clock synchronisers embodying the invention therefore find application in receivers for synchronous systems, such as audio systems. The state of the buffer is used to synchronise the local and remote clocks—when the buffer is more than half full the PLL on the receiver must speed up and when the buffer is less than half full the PLL on the receiver must slow down. The data is clocked into the buffer using the clock signal extracted from the received signal (i.e. using the received clock) and clocked out using the local clock. It will be appreciated that in synchronous data transmitter and receiver systems embodying the invention standard control theory is used to design the receiver PLL control loop such that the PLLs at either end are fully synchronised.

It should be noted that there is a subtle distinction between the remote clock, i.e. the clock as observable at the transmitter, and the received clock, i.e. the clock observable at the receiver. The long-term average frequency of the two is equal, so if a local clock is synchronised to the received clock, it is also synchronised to the remote clock. However, it is the received clock, with additional short-term jitter as described above, which is actually used in any signal processing at the receiver, and the receiver embodying the present invention attenuates this undesirable jitter and provides a reduced-jitter local clock signal and retimed data output stream.

It will be appreciated that the digital fill-level signal is indicative of an accumulated clock slippage, i.e. a slippage between the local and received clock signals. Furthermore, the elastic buffer can be regarded as a clock comparison circuit, detecting an asynchronism between the received and local clocks, and outputting a digital signal (the fill-level signal) that is indicative of the detected asynchronism. This digital signal is used to control the PLL to reduce the asynchronism, resulting in a condition where the frequency of the local clock has converged to the average frequency of the received clock, and consequently to the frequency of the remote clock, i.e. the clocks are then synchronised.

In certain preferred embodiments the data storage comprises a storage array and the elastic buffer comprises an input (write) counter adapted to record an input counter value, an output (read) counter adapted to record an output counter value, and a comparator. In such arrangements the elastic buffer in general (and in particular, for example, the input counter) is responsive to a clock pulse at the first clock input to increase the input counter value by a first increment, and the input counter is arranged to provide an input counter signal to the comparator, the input counter signal being indicative of the input counter value. The input counter also provides an input (write) pointer to the storage array, the input pointer being dependent on the input counter value. Additionally, the elastic buffer in general (and in particular, for example, the output counter) is responsive to a clock pulse at the second clock input to increase the output counter value by a second increment. The output counter is arranged to provide an output counter signal to the comparator, the output counter signal being indicative of the output counter value, and to provide an output (read) pointer to the storage array, the output pointer being dependent on the output counter value. The comparator is arranged to generate and output the digital fill-level signal according to the input and output counter signals, and the synchroniser arrangement is such that, in response to a clock pulse at the first clock input, data is clocked into the storage array to a location determined by the input pointer, and such that, in response to a clock pulse at the second clock input, data is clocked out of the storage array from a location determined by the output pointer.

The first increment and second increment may have equal magnitudes, or different magnitudes.

Preferably, the clock synchroniser (and in particular the elastic buffer EB further comprises increment control circuitry arranged to control the magnitude of the first and/or second increments.

In certain preferred embodiments the increment control circuitry (increment adjustment means) is arranged to control the first and second increments such that they have a common magnitude, and is further arranged to reduce this common magnitude from a first value to a second value as the local clock signal is brought into synchrony with the received clock signal. In other words, when the clocks are substantially out of synchrony, for example on start-up, the increment can be set to an initial, high value. As the clock frequencies are then brought together by action of the synchroniser, the increment can be gradually reduced to a minimum value (e.g. 1). This ramping of the increment according to degree of synchronisation enables frequency lock to be achieved more quickly than would be the case if the minimum increment were used throughout, yet provides a low-jitter local clock once synchronisation has been achieved.

Preferably, the storage array has a depth defined by a first number of clock pulses (cycles), the input counter is adapted to store a maximum input counter value, the output counter is adapted to store a maximum output counter value, and the maximum input and output counter values are each greater than the first number. The depth of the array thus represents the number of clock cycles to take it from empty to full.

More preferably, each of the maximum input and output counter values is greater than the first number (i.e. the buffer depth) by at least one order of magnitude.

In certain preferred embodiments, the input counter value is recorded by the input counter as a word comprising a plurality of digits (e.g. binary digits, or to some other base), and the input pointer is arranged so as to be independent of at least the most significant digit of this plurality of digits. Advantageously, the input pointer is provided by a plurality of the least significant digits of the word.

Similarly, the output counter value may be recorded by the output counter as a second word comprising a second plurality of digits (binary, or some other base), and the output pointer is arranged so as to be independent of at least the most significant digit of that second plurality of digits. The output pointer may be provided by a plurality of the least significant digits of the second word.

In certain preferred embodiments, the comparator is adapted to generate the fill-level signal by comparing the input and output counter signals to generate a number indicative of a difference between the counter values, and subtracting a predetermined number from that indicative number. The predetermined number may correspond, at least approximately, to half of the depth of the storage array, such that when the array is half full, the comparator output is approximately zero.

The control link may be a direct link, or preferably may include some scaling factor, preferably by a power of 2 to allow implementation as a simple bit-shift.

Additionally, the control link may comprise a digital filter arranged to filter the digital fill-level signal and produce a filtered output signal. The control link output signal may be used directly as the frequency control signal to the PLL, or alternatively the frequency control signal may be derived from the control link output signal

Advantageously, the reference oscillator (which can also be referred to as a local oscillator) comprises a crystal oscillator. By generating the local clock signal from the intrinsically clean, low-jitter reference signal from such a source, the local clock signal may itself be low-jitter.

Preferably, the controlled oscillator is a voltage controlled oscillator (VCO), although current-controlled and numerically-controlled oscillators (ICOs and NCOs) could be used in certain embodiments. Use of an NCO in particular would, however, increase the complexity of the circuit, requiring a greater number of components.

Preferably, the phase detector is a digital phase detector, arranged to provide a digital phase signal dependent on a phase difference between the signals at its first and second inputs. Conveniently, it may be a phase and frequency detector (PFD).

A particular preferred embodiment utilises a digital phase detector and a VCO in the PLL, the PLL further comprising a filter and a charge pump, the charge pump being controlled by the digital phase signal to supply current to the filter, and the filter being arranged to integrate the supplied current to provide a control voltage to the voltage controlled oscillator.

Advantageously, the phase-locked-loop circuit may comprise a controllable divider arranged in the feedback path from the controlled oscillator output to the phase detector, the divider being arranged to receive the frequency control signal and being controlled by the frequency control signal to set a frequency division value N along said path to determine a ratio of the local clock frequency to the reference frequency.

The value N is the factor by which the divider divides an input signal, i.e. it is the ratio of the respective frequencies of the signals at the divider input and output.

Thus, the control link may be arranged to receive the digital fill-level signal and to provide a control signal to the divider to adjust the frequency division value N according to the fill-level signal to alter the local clock frequency and reduce an asynchronism between the received and local clocks.

Compared with previously known circuits which used a filtered version of the EB fill level to drive a VCO directly via a digital-analogue converter (DAC) but needed the DAC to have a large number of ENOBS to achieve a good frequency resolution, circuits embodying the invention may bypass that problem by modulating the division ratio in the feedback path of a charge pump PLL, for example. In this way an effective accuracy limited by the digital resolution of the charge pump PLL can be achieved.

A clock synchroniser embodying the invention can thus provide the advantage that it is able to generate a low jitter local clock signal from the reference signal, synchronised with the received clock which may comprise a high level of jitter. The combination of synthesiser, clock comparison circuit in the form of the elastic buffer, and control link acting to reduce an asynchronism between the local and received clocks, may be regarded as a control loop. Jitter on the received clock is, in effect, decoupled from the local clock signal by the fact that this control loop has a low bandwidth, so the long-term average of the reference and local clock frequencies become equal, but higher frequency jitter components fall outside the bandwidth of the loop so do not pass through to the local clock. This low loop bandwidth is achieved by using digital means in the control path which adjusts the divider value (also known as the divider ratio) according to detected asynchronism. The use of digital means allows signals to be stored or integrated for long times without needing large-value analog components to achieve long time constants. This digital means may comprise a simple multiplier or bit-shifter, or may comprise a simple filter.

The frequency control signal to the divider may comprise the digital fill-level signal, or may be derived from the digital fill-level signal, such that the control signal is dependent on the fill-level signal. Thus, the frequency control signal determines, at least partially, the frequency division value set by the divider.

Clearly, the type of divider circuit used will determine what control signal or signals are required to achieve a particular division value or ratio. The control link is configured to generate and apply the appropriate control to the divider, to achieve the change in division ratio required by a detected change in fill-level (i.e. a detected asynchronism between local and received clocks). Control of the divider is such that the local and received clock frequencies converge.

Thus, the control link may, in certain embodiments, be a simple connection, conveying the digital fill-level signal to the divider. More preferably, the control link includes a scaling of this signal, either by a digital multiplier or implicitly by bit-shifting the signal.

The control link may also comprise at least one digital filter, filtering the fill-level signal and providing the filtered signal as a control signal to the divider. In such embodiments, the divider itself must incorporate circuitry to implement the required N change. In alternative embodiments, the control link may comprise a control circuit with a plurality of components, adapted to process the digital fill-level signal and provide a suitable control signal.

Preferably, the phase locked loop circuit is a fractional-N phase locked loop circuit, the divider being controllable to achieve a non-integer average value of N. Fractional-N PLLs are known in the art. For example, they may utilise dividers having internal circuitry that enables the value of N to change dynamically during the locked state. Dual modulus dividers may be used, which can change N between two values during a cycle (e.g. between P and P+1, where P is an integer), the relative portions of the cycle for each value determining the average N value. Tri- and higher-order modulus dividers are also known, enabling the N value to be controllably switched between 3 or more different values respectively.

The elastic buffer and the control link may together be referred to as a divider control circuit.

Preferably, the divider is a digitally controlled divider, and the frequency control signal from the control link comprises at least one digital control signal (the divider may require a plurality of control signals to achieve a desired N value, especially for non-integer values). For example, the digital control signal may comprise the digital fill-level signal. The control link may comprise an adder arranged to add the digital fill-level signal (or a signal derived from it, such as a filtered signal) to a second digital signal, the digital control to the divider signal being dependent on the sum of these digital signals. Thus, the second digital signal may represent a base value for N, and the first signal may represent an adjustment.

In certain embodiments, the control link may comprise a sigma-delta modulator arranged to receive an output signal from the adder, or directly from a digital filter if an adder is not explicit in the implementation, and generate the divider control signal.

In certain preferred embodiments, the divider is arranged to divide an output signal from the controlled oscillator (CO) and to provide the divided signal to the second input of the phase detector (i.e. the divider may be connected directly between the CO output and the PD input). In alternative embodiments, there may be additional circuit elements arranged between the controllable divider and the CO and/or the PD.

The synthesiser circuit may consist of the PLL circuit, or alternatively may comprise additional components. For example, it may comprise at least one further divider arranged to divide the output signal from the controlled oscillator to produce the local clock signal.

Another aspect of the invention provides a clock and data recovery circuit for recovering a clock signal and data from a data stream containing data and embedded clock information, the circuit comprising:
a data and clock extraction circuit having an input arranged to receive a data stream containing data and embedded clock information, the extraction circuit being arranged to generate and output an extracted clock signal according to the embedded clock information and to generate and output an extracted data signal according to the contained data; and
a clock synchroniser in accordance with the first aspect of the invention,
wherein the extracted clock signal is provided to the first clock input as the received clock signal and the extracted data signal is provided to the data input.

It will be appreciated that a variety of techniques for embedding clock information in data streams, and for extracting (recovering) a clock signal from such data streams are well known. These extraction techniques produce an extracted clock signal (i.e. the received clock signal) which still contains jitter.

The clock and data recovery circuit may be incorporated in a data receiver. The receiver provides the advantage that it attenuates jitter in the received data (the received data stream) down to low jitter frequencies to ensure low-distortion reproduction, and also avoids loss of data due to the jittery input clock and the clean output clock (the local clock) slipping past each other. That is, short-term (above audio frequency) and medium-term (audio frequency) variations in the received data rate are smoothed by the receiver to give a constant frequency output, but the long-term frequency of the regenerated clock and data are, generally, exactly equal to the received data rate. The received data rate, and the output data and clock rate are synchronised. The receiver achieves this by ensuring that the average local clock frequency matches the average received clock rate.

It is important to note that in a clock and data recovery circuit embodying the invention, received data is clocked into the elastic buffer using the jittery extracted clock, i.e. a clock signal in which the jitter has not been attenuated, rather than using a smoothed local clock. This ensures that all received data gets into the elastic buffer (albeit at a jittery rate). If a smoothed clock were used instead of the “raw” extracted clock, then some data might be lost in the process of inputting data to the elastic buffer. Once the data is safely in the elastic buffer, it is clocked out at the low-jitter local clock rate. Thus, data is not lost, and the data output rate is smooth (low-jitter), corresponding to the average rate at which data is provided to the circuit. Embodiments of the invention thus find application in synchronous data systems.

Although a variety of known clock and data extraction circuits may be used in embodiments of the invention, the data and clock extraction circuit preferably comprises a digital phase-locked loop circuit arranged to receive a further clock signal (e.g. a system clock) and the data stream, and to extract and output the extracted clock signal using the system clock.

The further clock signal is preferably provided by a reference oscillator, which may be the same reference oscillator that provides the reference signal to the PLL of the synthesiser.

The further clock frequency should be at least twice the typical (anticipated) clock frequency of the received data stream, and preferably at least four times as high.

Advantageously, the data and clock extraction circuit comprises a digital phase-locked loop circuit comprising:
a numerically controlled oscillator arranged to generate an oscillatory signal at an output;
a phase detector, having a first input arranged to receive the data stream and a second input arranged to receive an oscillatory signal via a feedback path from said output of the numerically controlled oscillator, and being arranged to output a phase error signal indicative of a phase difference between the signals provided to its first and second inputs; and
a filter arranged to filter the phase error signal and provide an output signal to control the numerically controlled oscillator to determine a frequency of the oscillatory signal at the output of the numerically controlled oscillator.

The received clock signal, provided to the elastic buffer, may be the oscillatory signal from the output of the numerically controlled oscillator, or may be derived from that signal.

Another aspect of the invention provides a clock synchroniser for generating a local clock signal synchronised to a received clock signal, comprising:
a reference oscillator arranged to provide a reference signal having a reference frequency;
a synthesiser circuit arranged to synthesise a local clock signal from the reference signal, the synthesiser circuit comprising a phase-locked-loop circuit including a phase detector, having a first input arranged to receive the reference signal, and a controllable divider arranged in a feedback path from a controlled oscillator to a second input of the phase detector, the divider being controllable to set a frequency division value N along said path to determine a ratio of the local clock frequency to the reference frequency;
a clock comparison circuit arranged to receive the local clock signal and a received clock signal, and adapted to generate a first digital signal indicative of an asynchronism between the local and remote clock signals; and
a control link linking the clock comparison circuit to the divider, the control link being arranged to receive the first digital signal and to provide a control signal to the divider to adjust the frequency division value N according to the first digital signal to alter the local clock frequency and reduce the asynchronism,
wherein the clock comparison circuit comprises an elastic buffer comprising data storage adapted to store data, and the elastic buffer having a data input for receiving data, a first clock input for receiving the received clock signal, a data output for outputting data, and a second clock input arranged to receive the local clock signal from the synthesiser circuit,
the elastic buffer being responsive to a received clock signal at the first clock input to clock data provided to the data input into the data storage (at a received clock rate), and being responsive to the local clock signal at the second clock input to clock data out of the data storage (at a local clock rate),
the elastic buffer being adapted to output said first digital signal, said first digital signal being a digital fill-level signal indicative of the quantity of data stored in the data storage,
and the control link being arranged to control the local clock frequency to maintain a desired average quantity of data in the data storage.

The elastic buffer may incorporate one or more of the advantageous features described above with reference to the first aspect. For example, it may comprise write and read counters and a comparator, the counters being incremented in response to clock pulses at the first and second inputs and providing pointer signals to the data storage array. Again, the read and write pointers may preferably be provided by least significant bits from the counters.

Another aspect of the present invention provides a method of generating a local clock signal synchronised to a received clock signal, comprising the steps of:
generating a reference signal having a reference frequency;
synthesising a local clock signal from the reference signal using a phase-locked loop circuit;
providing a received clock signal to a first clock input of an elastic buffer comprising data storage adapted to store data;
providing data to a data input of the elastic buffer;
providing the local clock signal to a second clock input of the elastic buffer, the elastic buffer having a data output for outputting data and being responsive to the received clock signal at the first clock input to clock data provided to the data input into the data storage (at the received clock rate), and being responsive to the local clock signal at the second clock input to clock data out of the data storage (at the local clock rate);
generating and outputting from the elastic buffer a digital fill-level signal indicative of the quantity of data stored in the data storage; and
using the digital fill-level signal to control the phase-locked-loop circuit to control the local clock frequency to maintain a desired average quantity of data in the data storage.

Advantageously, the method may further comprise the step of filtering or scaling the digital fill-level signal, for example with a digital filter, and using the filtered or scaled digital fill-level signal to control the phase-locked-loop circuit.

Preferably, the phase-locked-loop circuit comprises a controllable divider, arranged in a feedback path from a controlled oscillator to a phase detector and controllable to set a frequency division value N along said path to determine a ratio of the local clock frequency to the reference frequency, and the method comprises the step of using the digital fill-level signal to control the divider.

Preferably, the data storage comprises a storage array and the elastic buffer comprises an input counter adapted to record an input counter value, an output counter adapted to record an output counter value, and a comparator, the method further comprising the steps of responding to a clock pulse at the first clock input by increasing the input counter value by a first increment, providing an input counter signal to the comparator from the input counter, the input counter signal being indicative of the input counter value, providing an input pointer to the storage array, the input pointer being dependent on the input counter value,
responding to a clock pulse at the second clock input by increasing the output counter value by a second increment, providing an output counter signal to the comparator from the output counter, the output counter signal being indicative of the output counter value, providing an output pointer to the storage array, the output pointer being dependent on the output counter value,
using the comparator to generate and output said digital fill-level signal according to the input and output counter signals,
responding to a clock pulse at the first clock input by clocking data into the storage array to a location determined by the input pointer, and in responding to a clock pulse at the second clock input by clocking data out of the storage array from a location determined by the output pointer.

Certain preferred methods embodying the invention further comprise the step of controlling the magnitude of at least one of the first and second increments.

They may comprise the step of adjusting the magnitudes of the first and second increments as the local clock signal is brought into synchronisation with the received clock signal.

Advantageously, the method may comprise the steps of controlling the first and second increments such that they have a common magnitude, and reducing said common magnitude from a first value to a second value as the local clock signal is brought into synchrony with the received clock signal.

The method may comprise the steps of recording the input counter value as a word comprising a plurality of digits, and using only a least significant part of the word (e.g. the 3 or 4 least significant bits, out of a word length of, say, 8 or more bits) as the input pointer.

Similarly, the method may comprise the steps of recording the output counter value as a second word comprising a second plurality of digits, and using only a least significant part of the second word as the output pointer.

The step of using the comparator to generate the fill-level signal preferably comprises comparing the input and output counter signals to generate a number indicative of a difference between the counter values, and subtracting a predetermined number from that indicative number.

It will be appreciated that, in certain preferred embodiments, the elastic buffer counters can be made wide enough to cope with a large range of frequency offset but the data storage in the EB only needs to be large enough to absorb the maximum amount of jitter that is expected when the clocks are synchronised. This allows a separation of the acceptable frequency range (set by the size of the counters) and also of the maximum acceptable jitter on the clocks (set by the size of the elastic buffer). Otherwise a system which had to cope with octaves of different input frequencies (but with a small amount of jitter oat each speed) would need a very large EB to accommodate this frequency range. Such an EB would dominate the circuit design in terms of area.

Embodiments of the invention may be used in data receiver circuits and provide the advantage that they generate a clean clock locally and retime the incoming data to this clock prior to a digital-to-analogue converter to avoid clock-jitter induced noise and distortion. The local clock and the incoming data clock are synchronised and data loss is avoided.

Other objects and advantages of the present invention will become apparent from the following description.

### BRIEF DESCRIPTION OF THE FIGURES

Embodiments of the invention will now be described with reference to the accompanying drawings, by way of example only and without intending to be limiting, of which:

FIG. 1 is a schematic representation of a data transmit and receive system in accordance with the prior art;

FIG. 2 is a schematic representation of a data and clock recovery circuit embodying the invention;

FIG. 3 is a schematic representation of the components of the DPLL from FIG. 2;

FIG. 4 is a schematic representation of an elastic buffer suitable for use in embodiments of the invention;

FIG. 5 is a schematic representation of a clock synchroniser circuit embodying the invention;

FIG. 6 is a schematic representation of another clock synchroniser circuit embodying the invention;

FIG. 7 is a schematic representation of a synthesiser circuit and reference oscillator suitable for use in embodiments of the invention; and

FIG. 8 is a schematic representation of another data and clock recovery circuit embodying the invention

FIG. 9 is a schematic representation of another elastic buffer suitable for use in embodiments of the invention; and

FIGS. 10a-10c show open loop and closed loop responses in circuits embodying the invention, corresponding respectively to (a) no digital filter, (b) integrator plus zero<1/beta, (c) low-pass filter, corner frequency>1/beta.

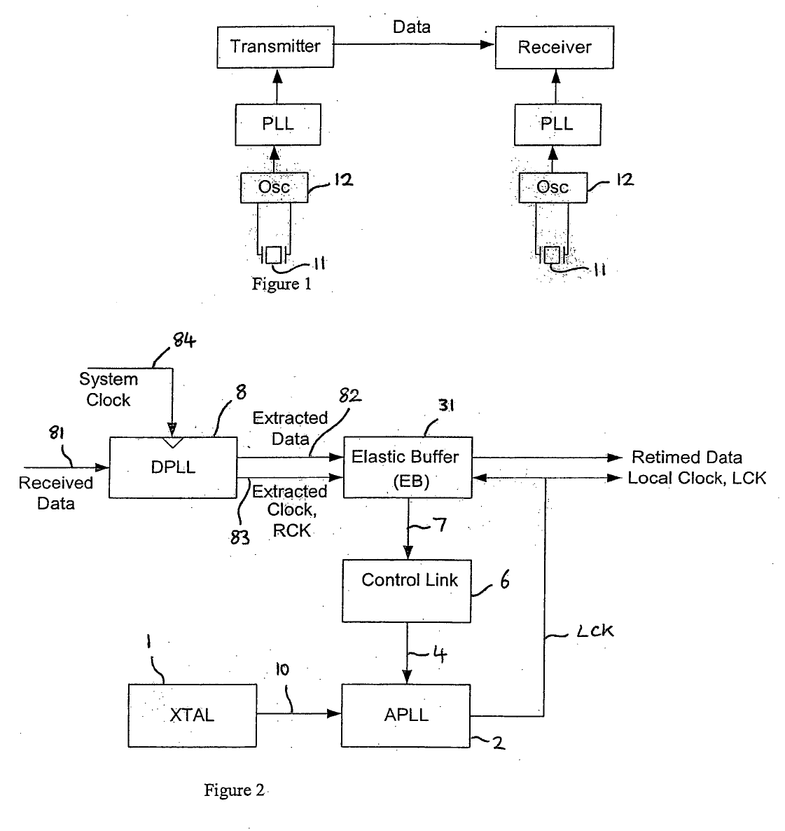

### DETAILED DESCRIPTION OF EMBODIMENTS OF THE INVENTION

Referring now to FIG. 2, a clock and data recovery circuit (system) embodying the invention includes a clock and data extraction circuit 8 that comprises a digital phase locked loop (DPLL). A stream of received data 81 containing embedded clock information is supplied to the DPLL, which is used to lock onto the incoming data and generate an internal intermediate clock RCK 83 (which shall be referred to as the received clock) and a stream of retimed internal data 82 (i.e. extracted data). The generation of the internal intermediate clock may also be described as the extraction of a clock signal from the stream of received data, and hence the internal intermediate clock may also be referred to as an extracted clock.

The extracted data 82 and the extracted clock 83 are provided to inputs of an elastic buffer (EB) 31. The EB is used to absorb any short or medium term timing variations between the local and remote clock domains. It also generates a pointer error signal (P) 7 indicating the amount of data stored in the buffer's storage means (memory), and hence indicating the current accumulated jitter or time-domain slip of the retimed internal data.

A control link 6 may be a simple connection of the EB pointer error signal to the frequency control input of an analogue PLL of a frequency synthesiser. Preferably it will include some scaling of the digital signal to scale the effect of a single LSB (least significant bit) change in pointer error signal on the target frequency of the PLL.

The control link may also include some digital filtering to provide additional design freedom in tailoring the jitter transfer function of the system.

A stable reference signal 10 at a reference frequency is provided to the APLL by a high quality clock source 1 such as a crystal oscillator (XTAL).

The analogue phase locked loop (APLL) generates a spectrally clean clock LCK from the high quality clock source, its output frequency being controlled by the frequency control signal 4 output from the control link. There are a number of ways in which the frequency control signal 4 from the control link can be used to control the APLL output frequency, and hence the LCK frequency (rate). For example, the signal 4 could be mixed with a filtered or integrated signal derived from the output of a phase detector of the PLL, to alter the control voltage applied to a VCO of the PLL. In this case a low-bandwidth APLL, with bandwidth below the audio band, would be required, to avoid the APLL suppressing this secondary control input over the audio band. However, in certain preferred embodiments the frequency control signal 4 is provided to a feedback frequency divider of the APLL. The APLL may then be high-bandwidth, with bandwidth above the audio band, with advantages in suppression of audio-frequency VCO noise as well as reduced loop filter component values. The spectrally clean low-jitter clock from the APLL is used to provide an output clock signal LCK and to retime data out of the system.

In this example the DPLL is clocked by a system clock 84, typically from an external crystal, either directly or via another PLL. It recovers a clock 83 from the incoming data stream 81, and extracts and outputs data 82 from this stream with this clock 83.

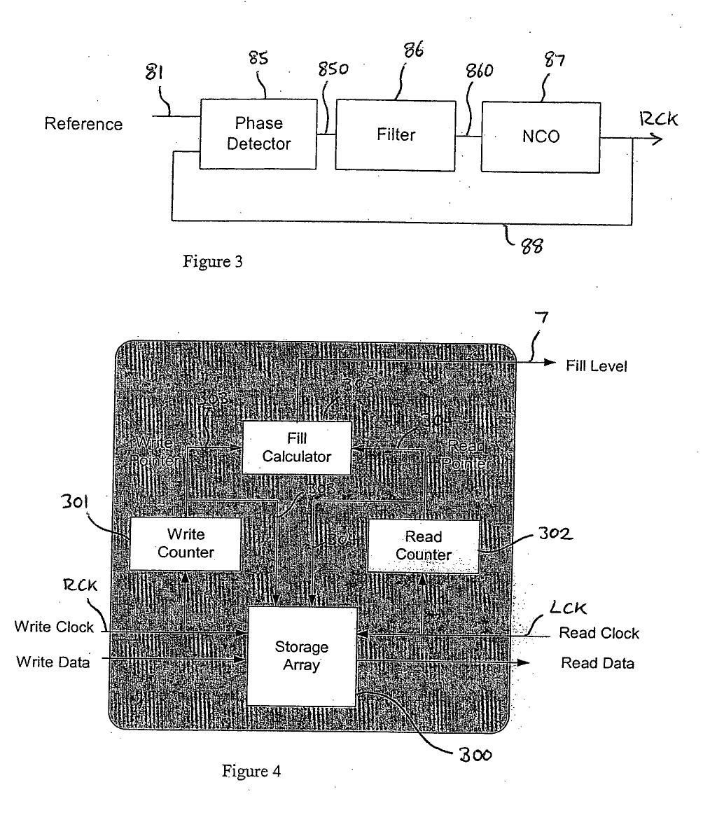

FIG. 3 shows the components of a suitable DPLL. The DPLL includes a phase detector PD 85 to detect a phase difference between its output recovered clock 83 and the received remote clock (i.e. the clock embedded in the received data stream). The phase detector can be realised in a variety of ways—e.g. an XOR gate, a counter or a JK-flip flop. The next stage is an integrating low pass filter 86 which converts the phase error signal 850 into a digital signal 860 representing frequency error. This filter is usually realised as a low order IIR (infinite impulse response). This output 860 from this filter is used to drive a Numerically Controlled Oscillator (NCO) 87. The NCO is a digital oscillator that produces a square wave whose frequency is proportional to the code coming from the filter.

The timing resolution of the clock and data extraction circuit (i.e. the detector) is that of the system clock, so the jitter on the output of the NCO is limited by the frequency of operation of the DPLL. The DPLL must be over sampling the incoming clock in order to function properly. As per the Nyquist criterion the DPLL needs to be clocked at least as twice as fast as its input. However in practice to reduce time domain quantisation errors and improve the tracking ability of the DPLL it tends to be at least four times over sampled.

The DPLL outputs have a resolution in time of the external clock period, so intrinsically has high-frequency jitter of this order, even with jitter-free inputs. So the minimum jitter of the recovered clock running on a 100 MHz clock will typically be of the order of ten nanoseconds pk-pk. The faster the DPLL is run the smaller this component of the output jitter.

The filter bandwidth must be chosen in such a way to ensure it can track the short-term timing variations of the jittery incoming data, but this means it also does not attenuate incoming jitter within this bandwidth. The incoming jitter could be several microseconds peak-to-peak for SPDIF (Sony/Philips Digital Interface) audio data. If the jitter on the clock output from the DPLL has strong sinusoidal tones, and if this clock were then used to clock a DAC to reconstruct the audio signal, then spurs may fall into the audio band which will degrade the quality of the audio out of the DAC.

In alternative embodiments, other forms of clock and data extraction circuits may be used to provide the inputs to the EB. For example, various analogue solutions (e.g. Costas loop, see Proakis, “Digital Communications”, McGraw-Hill Higher education, 2000, ISBN 0-07-232111-3, pp. 347-359) have been proposed, and could be used. However, a DPLL is smaller and more versatile than these. The DPLL can also be used to track data types other than NRZ (non-return-to-zero), such as Manchester encoded and PAM-3 etc. Traditionally, recovering (extracting) clocks from Manchester encoded data has been non-trivial due to the fact that there is no power at the clock frequency.

The function of an EB, as incorporated in embodiments of the invention, is essentially that of a buffer with asynchronous read and write interfaces. Various implementations are possible. A schematic of a suitable EB architecture is shown in FIG. 4.

This example 31 includes data storage means 300 in the form of an array of storage elements. Input data are written to these elements sequentially according to an input pointer 303 generated by a counter 301 driven at the clock rate RCK of the incoming data, in this case the recovered jittery clock from the DPLL. Data is read sequentially from the array according to an output pointer 304 generated by another counter 302 clocked at the desired output data rate, in this case the clock LCK generated by the APLL. A fill calculator 305 receives the two pointer signals 303,304 and outputs a fill-level signal that is indicative of the amount of data currently held in the EB memory. In this example, the write and read pointers are provided to both the fill calculator, as signals indicative of the current values/contents of the counters, and to the storage array to determine the locations to be written to and read from.

The EB 31 needs to be large enough to absorb the medium term variation in accumulated jitter that will arise from the jitter on the recovered data. EBs often find use in ensuring that data is not lost over a specific time frame. For an input frequency of R and an output frequency with an offset of Q in ppm the frequency offset is ΔR

$$Δ R = \frac{R \cdot Q}{{10}^{6}}$$

For a buffer of size B the time, Tₛₗᵢₚ, which can elapse before data is lost/repeated is

$${T}_{slip} = \frac{B}{Δ R}$$

Even small frequency offsets can lead to frequent data loss. For example if data is clocked into a 16-bit deep EB at 6.144 Mhz and clocked out with a relative frequency offset of 1 ppm, Tₛₗᵢₚ is just under three seconds.

Within the bandwidth of the overall control loop the jitter will be tracked but since the control loop will typically have a bandwidth of a few hertz it is essential that enough data is absorbed by the EB to cope with the jitter above this bandwidth.

The method of calculating the required depth of buffer depends on whether the jitter is specified as r.m.s. or peak-to-peak.

For r.m.s. jitter, σ_{long-term} (integrated over frequencies above the bandwidth of the control loop, which will be typically very low frequency, a few Hz), and a bit error rate (BER) , the peak-to-peak elasticity in time, T_{elastic}, of elastic buffer required can be shown to be
T_{elastic}=α.σ_{long-term}
where α satifies the equation

$$BER = \frac{erfc ( \frac{α}{2 \sqrt{2}} )}{2}$$

T_{elastic} must be calculated for both the clocks applied to the EB, i.e. RCK and LCK. There will be data loss at the specified BER if the elastic buffer can cope with pointer excursions up to sum of T_{elastic} for both the clocks without the pointers passing each other. For audio S/PDIF data encoded at 6.144 MHz a BER of 10⁻¹⁵ corresponds to loosing a bit of data every five years. For a BER of 10⁻¹⁵, a can be shown to be 15.888.

Hence B, the number of requisite bits in the elastic buffer, can be shown to be

$$B = \frac{{T}_{elastic\_local} + {T}_{elastic\_remote}}{{T}_{data}}$$

Where T_{data} is the data rate.

Typically B will be small. The jitter on the local clean clock LCK will be small compared to the clock RCK. For the above example of 10 ns r.m.s. intrinsic jitter from the DPLL, and a BER of 10⁻¹⁵, with a typical SPDIF data clock frequency of 6.144 MHz, T_{elastic}=15.888*10 ns, hence B=158 ns*6.144 MHz=˜1.

For peak-to-peak jitter, the calculation is simpler. To cope with 10UI (i.e. 10/6.144 MHz) peak-to-peak jitter, an EB depth of 10 would be required, though preferably B will be larger than this minimum to improve overload behaviour, reduce lock time and ensure linear transient operation.

As the incoming clock RCK slows down or speeds up relative to the output clock LCK the difference between the input and output pointers will vary. The difference between the two pointers can be regarded as a pointer error signal corresponding to the number of data bits stored, which will increase if the incoming clock speeds up or decrease if the incoming clock slows down relative to the clock generated by the APLL. This output will usually switch at least between two adjacent values, typically many more if there is large short-term jitter on the input data stream. It will thus have large high-frequency components, but will tend to drift up or down to track the relative frequencies of the input data clock and the clock generated by the APLL. The pointer error signal can be regarded as a measure of the slippage between the two clocks. In other words, the digital pointer signal 7 (fill-level signal) is indicative of an asynchronism between the local and received clocks.

The larger the size of the elastic buffer the larger the maximum error possible and hence the quicker the lock time. For low jitter systems the EB may be larger than the minimum depth of buffer needed thus ensuring correct loop dynamics.

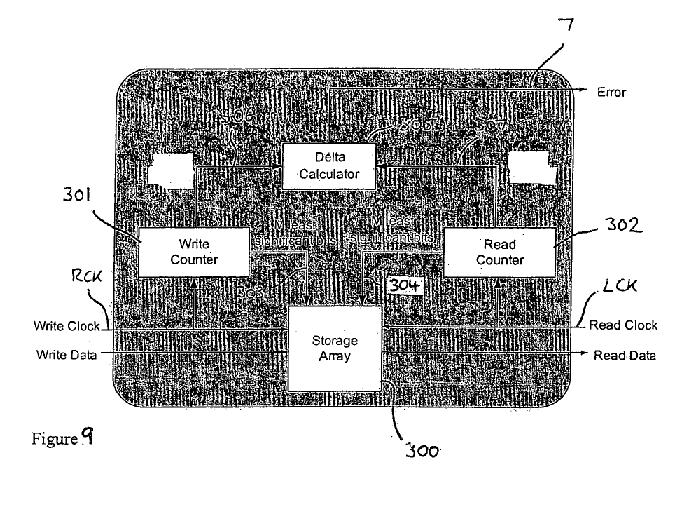

In overload or start-up conditions, it is acceptable to lose data, while as wide a range as possible of pointer error signal is still advantageous to allow linear operation of the overall loop. Thus the counters calculating the error signal may be of a wide word width, but the buffer may be much reduced depth, controlled by just a few LSBs of the pointers. FIG. 9 shows an EB where the buffers are controlled by LSBs in this fashion.

The data storage comprises a storage array 300 and the elastic buffer comprises an input (write) counter 301 adapted to record an input counter value, an output (read) counter 302 adapted to record an output counter value, and a comparator (delta calculator 305). The write counter is responsive to a clock pulse at the first (i.e. write) clock input to increase the input counter value by a first increment. The input counter provides an input counter signal 306 to the comparator 305, the input counter signal being indicative of the input counter value, and provides an input (write) pointer 303 to the storage array, the input pointer being dependent on the input counter value. In this example, the input/write pointer corresponds to the M least significant bits of the write counter stored word, where M is an integer. The write pointer is thus independent of the most significant bits. The read counter 302 is similarly responsive to a clock pulse at the read clock input to increase the output counter value by a second increment. The output counter provides an output counter signal 307 to the comparator, the output counter signal being indicative of the output counter value, and provides an output (read) pointer 304 to the storage array. The output pointer corresponds to the M least significant bits of the read counter stored word. The comparator generates and outputs the digital fill-level signal 7 (which may also be referred to as an error signal) according to the input and output counter signals (i.e. according to the difference between the counter values. The elastic buffer is arranged such that, in response to a clock pulse at the first clock input, data is clocked into the storage array to a location determined by the input pointer, and such that that in response to a clock pulse at the second clock input data is clocked out of the storage array from a location determined by the output pointer.

In steady-state, the EB will preferably be half full, to allow equal headroom for increasing and decreasing input frequency transients. To give a signal near zero to pass forward as the error signal 7 to the PLL, a number equal to half the depth of the buffer may be subtracted by the comparator 305.

The output frequency of the APLL , Fₒᵤₜ, is given by
Fₒᵤₜ=N* F_{ref}

F_{ref} is the frequency of the crystal, N is the value used for division in the feedback path of the PLL. Hence the output frequency of the APLL can be adjusted by changing N. It is often desirable to have the VCO frequency running faster than needed and dividing that clock down to the desired rate to achieve a low phase noise. For r.f. applications the divider ratio is often large, and adequate frequency resolution may be obtained with an integer divider ratio. But more commonly, a non-integer divider ratio is needed to provide adequate frequency resolution. Using fractional-N techniques, the output frequency of the PLL can be adjusted to the resolution to which N is represented.

As stated above, the EB will generally only be a few stages long, so the pointer error signal P, 7, will typically be only a few bits of resolution, and will tend to hunt between a few adjacent values. To avoid big jumps in the target frequency of the APLL, P should be attenuated by scaling by a scale factor β, so

$$\begin{matrix}Δ {F}_{out} = Δ {N}^{*} {F}_{ref} \\ = β \cdot P \cdot {F}_{ref}\end{matrix}$$

The speed at which the APLL output frequency will respond to the input ΔN is limited by the bandwidth or slew rate of the APLL However the loop bandwidth of the APLL will typically be tens of kHz, whereas the overall loop bandwidth will typically be only a few Hz, so the extra pole due to the APLL can normally be ignored

The elastic buffer has an inherent integration property and has the transfer function:

$${T}_{EB} = \frac{P}{{F}_{RCK} - {F}_{LCK}} = \frac{1}{z - 1}$$

where F_{RCK} and F_{LCK} are the frequencies of the extracted clock RCK and local clock LCK respectively and z is defined (to first order) with respect to the steady-state LCK frequency f_{LCK0}.

Thus the overall open-loop transfer function is

$${T}_{OL} = \frac{β}{z - 1}$$

hence the closed loop transfer function is

$${T}_{CL} = \frac{{F}_{LCK 0}}{{F}_{RCK}} = \frac{β}{z - 1 + β}$$

which is a single pole system with a pole at z=1−β. Hence the system has a bandwidth which is set by β. From the expression for the loop transfer function the −3 dB point can be shown to be

$${f}_{- 3 d B} \approx \frac{{F}_{LCK 0} β}{2 π}$$

and the lock time can be shown to be

$${T}_{lock} \approx \frac{10 π}{{F}_{LCK 0} β}$$

In certain preferred embodiments a fast lock time may be achieved by changing the increment value into the integrators (i.e. the read and write counters). Such embodiments thus comprise increment control (i.e. adjustment) circuitry. Previously, as described above, the integrators have only been increasing by one. A faster lock time may be achieved by increasing the number (the increment) that the integrators increment by every clock cycle. When the integrators increment by Γ rather than 1 this has the same effect of changing the gain inside the loop from β to β′ where
β′=β×Γ

Hence changing the integrator increment from 1 to 4 reduces the lock time by a factor of 4. In preferred embodiments, once the system has locked, the increment on the integrators may be reduced to 1 to achieve the desired resolution in N. In practice it is desirable to ramp Γ from maximum to minimum smoothly to achieve a smooth dynamic response. Thus, certain preferred embodiments comprise means for setting an initial increment magnitude, and for then reducing the increment magnitude as synchronisation is achieved. Thus if the integrators increment with a step of Γ then the lock time and bandwidth now become

$${f}_{- 3 dB} \approx \frac{{F}_{LCK 0} βΓ}{2 π} and {T}_{lock} \approx \frac{10 π}{{F}_{LCK 0} βΓ}$$

If β is too large, the loop bandwidth will be high, but the high-frequency components of the EB pointer error signal will modulate N at high frequency, and cause significant high-frequency output jitter from the APLL clock. If β is too small, the loop bandwidth will be low, so the overall loop will not respond fast enough to medium frequency components of jitter and the buffer size of the EB must be enlarged enough to cope with the consequent additional relative clock slippage.

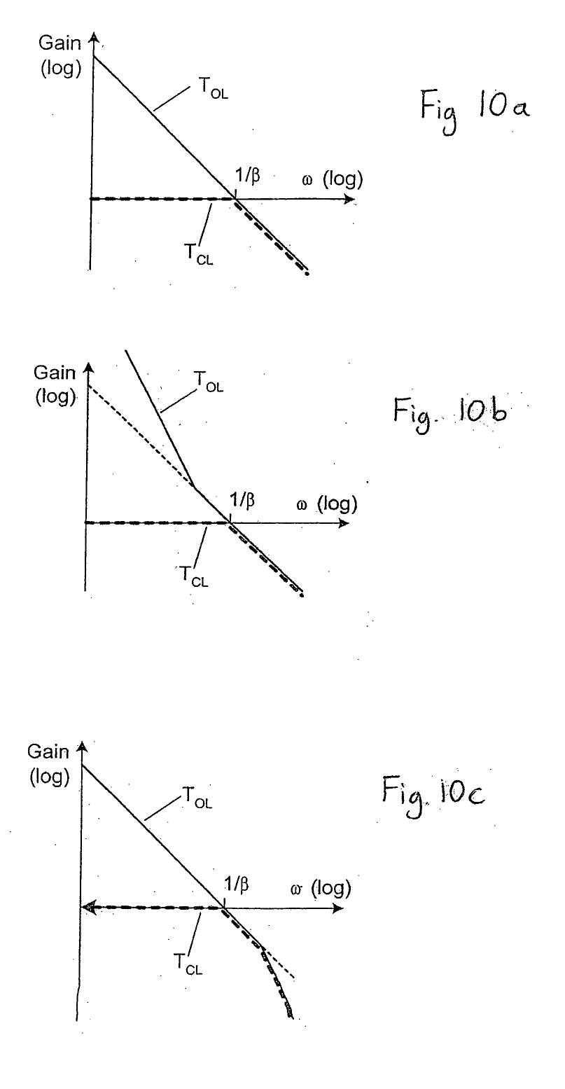

FIG. 10a illustrates the low-frequency open loop and closed loop frequency transfer functions of the loop. It is possible, in certain embodiments, to include a digital filter in the control link to tailor the dynamics of the loop. This could attenuate any high-frequency components of P before application to the APLL, to avoid any consequent high-frequency output jitter from the APLL clock, while not attenuating lower-frequency components to preserve the loop bandwidth.

A simple integrator gives higher loop gain at low frequencies and allows low-frequency components of the frequency control signal ΔN to have a larger dynamic range than the EB pointer error signal P, to improve performance when handling large amplitude jitter or in start-up. However this is achieved more simply by using the EB of FIG. 9. Also the use of a simple integrator would lead to two integrations in the loop, which would be unstable, so an additional zero is required to ensure overall system stability. This digital filter then has the transfer function:

$${T}_{FILTER} = \frac{Δ N}{P} = K \frac{z - Ψ}{z - 1}$$

where K and Ψ can be adjusted to optimise the loop bandwidth.

Hence the overall loop transfer finction is given by

$${T}_{loop} = \frac{K ( z - Ψ )}{{( z - 1 )}^{2} + K ( z - Ψ )}$$

The zero Ψ will generally have to be an octave below the loop bandwidth, FIG. 10b illustrates the transfer function achieved. This shows that the zero nullifies the effect of the integrator pole on frequency components of P above the bandwidth of the loop, so the introduction of this digital filter will not lead to attenuation of high frequency components of P.

Since the loop bandwidth will be low (typically 1 Hz) the lock times will be substantial (˜1 s). It is possible to reduce the lock time varying K and Ψ to change the bandwidth during start up. In this way the bandwidth can be reduced from Nyquist to sub 1 Hz in short period of time (ms).

FIG. 10c illustrates the transfer function achieved if the added digital filter is a low-pass filter, with corner frequency above the loop bandwidth to avoid impacting loop stability. This leads to higher attenuation of P at frequencies above this corner frequency and hence well above the loop bandwidth. This gives higher attenuation of high frequency jitter from the extracted clock RCK to the output clock LCK. However this does not improve performance for jitter at frequencies around the loop bandwidth.

For some applications, the combination of this low-pass filter and the modified EB of FIG. 9 will offer a good solution

Further combinations of these ideas or the use of other digital filter transfer functions could be readily derived and analysed in a similar fashion by those expert in this art.

Use of a digital filter allows high gain and long time constants to be easily and economically achieved, compared to the analogue filter of a conventional APLL approach, which would need large off chip filter components. This is especially important in portable systems. In cost sensitive designs the cost reduction of not using off chip components and improving performance is a significant advantage over traditional approaches.

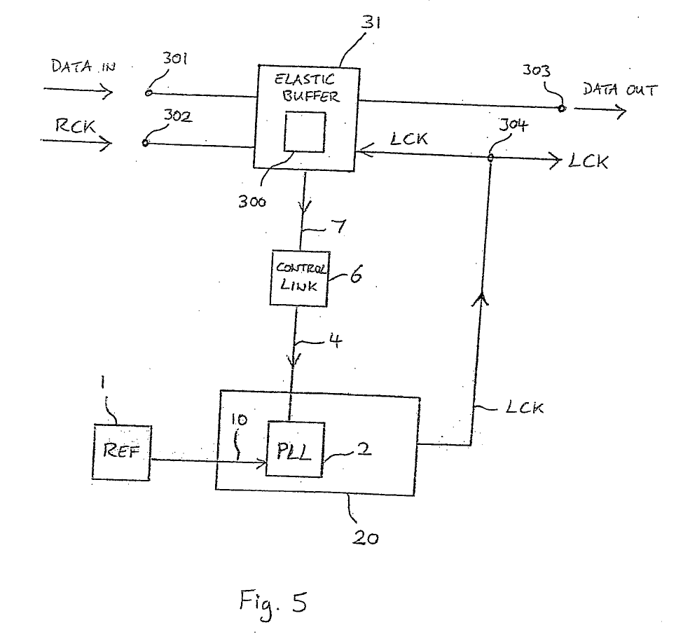

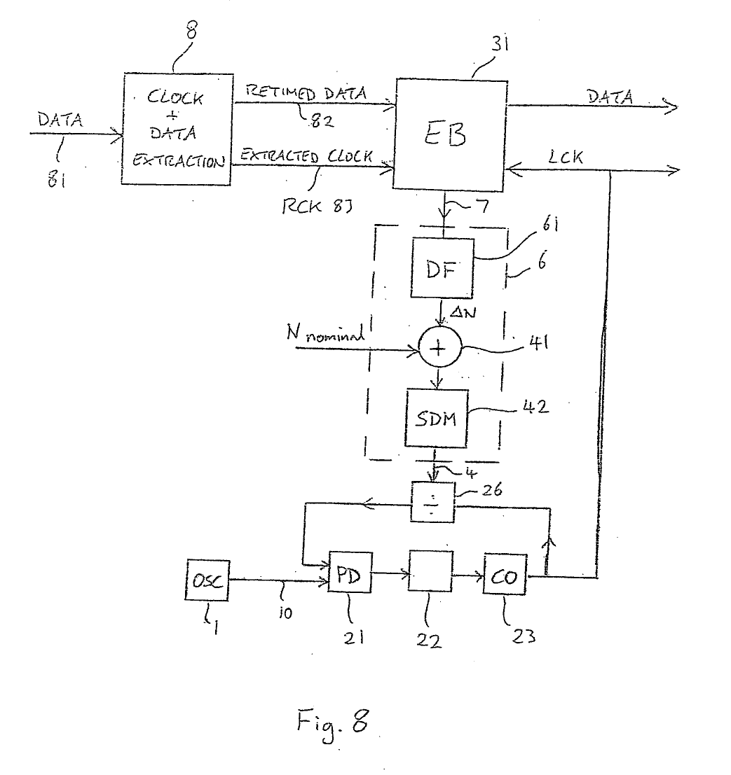

Referring now to FIG. 5, this shows a clock synchroniser embodying the invention. The synchroniser comprises a reference oscillator 1 arranged to provide a reference signal 10 having a reference frequency, a synthesiser circuit 20 arranged to generate a local clock signal LCK from the reference signal, an elastic buffer 31 comprising data storage 300 adapted to store data, and a control link 6 linking the elastic buffer to the synthesiser circuit. The synthesiser circuit 20 comprises a phase-locked-loop circuit 2, whose components are not shown in FIG. 5, but are the same as those of the PLL illustrated in FIG. 8. The PLL includes a controlled oscillator 23 arranged to receive an oscillator control signal and to generate, at a controlled oscillator output, an oscillatory output signal having a frequency dependent on the oscillator control signal and which determines the local clock signal frequency. The PLL also includes a phase detector 21, having a first input arranged to receive the reference signal, and a feedback path from the controlled oscillator output to the phase detector and providing an oscillatory signal to a second input of the phase detector, such that the phase detector generates an output signal indicative of a phase difference between the reference signal at said first input and the oscillatory signal at said second input. The PLL also comprises an oscillator control signal generating circuit 22 arranged to receive the output signal of the phase detector and to generate the oscillator control signal according to the phase detector output signal.

The elastic buffer 31 has a data input 301 for receiving data, a first clock input 302 for receiving a received clock signal RCK, a data output 303 for outputting data, and a second clock input 304 arranged to receive the local clock signal LCK from the synthesiser circuit 20. The elastic buffer 31 is responsive to a received clock signal at the first clock input to clock data provided to the data input into the data storage (at a received clock rate), and is responsive to the local clock signal at the second clock input to clock data out of the data storage (at a local clock rate). The elastic buffer outputs a digital fill-level signal 7 indicative of the quantity of data stored in the data storage, and the control link 7 is arranged to receive the digital fill-level signal and to provide a frequency control signal 4 to the phase-locked-loop circuit 2 to control the frequency of the oscillatory output signal according to the digital fill-level signal. Thus, the local clock frequency can be controlled to maintain a desired average quantity of data in the data storage, thereby synchronising the local clock to a received clock.

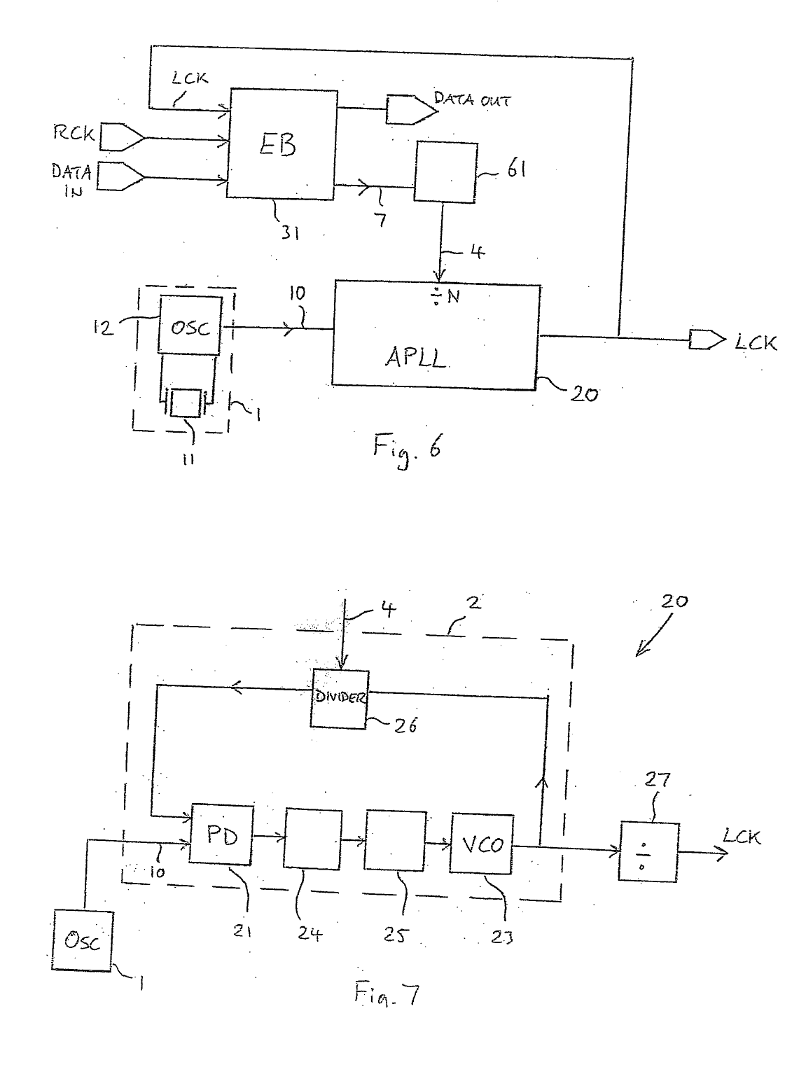

FIG. 6 shows a clock synchroniser similar to that of FIG. 5. In the circuit of FIG. 6, the EB 31 is functioning as a clock comparison circuit, the digital fill-level signal being indicative of an asynchronism between the received and local clocks. The fill-level signal is filtered by a digital filter 61, the smoothed output from which provides fine digital control to a control input of an APLL to set the division ratio N in its feedback path. The synthesiser circuit consists of the APLL in this example.

FIG. 7 shows the components of a synthesiser circuit 20 and reference oscillator 1 suitable for use in embodiments of the invention. The APLL VCO 23 will typically run at a high frequency to allow low phase noise. As shown, the synthesiser comprises a further divider 27. The output system clock LCK is divided down, using the divider 27, from the VCO output for maximum resolution in frequency. To reduce hardware some of the stages of divider 27 and the feedback divider 26 could be shared. However, this would be equivalent to just having a reduced-frequency VCO which is undesirable as limiting resolution of the feedback divider. Although the PLL 2 in FIG. 7 is referred to as an analogue PLL, it does incorporate a digital phase detector 21 in the form of a phase and frequency detector (PFD). This generates a digital output. The digital phase detector output is used to control a charge pump (or pumps) 24, which in turn supplies charge (current) to a loop filter 25. The loop filter integrates the supplied current and provides a control voltage to the VCO 23. The filter voltage, controlling the VCO, is thus a continuous (i.e. non-digital) control parameter, and it is for this reason that the circuit is referred to as an APLL.

FIG. 8 shows a data and clock recovery circuit embodying the invention. The circuit employs a data and clock extraction circuit 8 which receives the raw data stream 81, extracts the jittery clock signal, and uses the jittery clock to generate and output a retimed data stream 82. The elastic buffer generates and outputs, to the control link 6, a digital fill-level signal 7, indicative of accumulated slippage between the extracted and local clocks. The control link may optionally include a digital filter 61 which filters the varying fill-level signal and outputs a smoothed signal representative of a desired change (delta N) in the feedback divider ratio to counter the clock asynchronism. The output from the filter 61 is added to a nominal divide ratio using an adder 41, and the adder output (the sum of the two digital signals) is then input to a sigma delta modulator (SDM) 42 to use noise shaping to control the APLL divider 26 and achieve a fractional frequency multiplication with low APLL output jitter. The low jitter LCK is used to further retime data out of the EB.

It will be appreciated that methods and circuits embodying the present invention provide the advantage that they allow for a large amount of jitter on the incoming clock and can still produce a stable clock suitable for use with converters (i.e. DACs, in audio systems for example).

The loop bandwidth is defined by the digital scaling factor beta (β), possibly in conjunction with the characteristics of the optional digital filter 61. This allows a much lower bandwidth than can be achieved with the use of off-chip filters. The on-chip silicon implementation is small and efficient.

The spectral purity of the local clock is very important to applications where jitter can limit performance (ADCs, DACs etc.) The methods and apparatus embodying the invention allow a locally generated clock of high spectral purity to be synchronised to a local clock and this can be used to run converters.

It will also be apparent that particular embodiments of the invention provide methods and circuitry for receiving jittery data from a remote source and generating a local clock from this data. The locally generated clock is synchronised to the remote data and can attenuate the jitter on this remote data down to low jitter frequencies (sub 1 Hz). This is critical for many applications such as digital audio receivers. The circuits may contain a digital phase-locked loop (DPLL) for generating an intermediate clock (which we refer to as the received clock, i.e. the clock signal provided to the elastic buffer to clock data in), an elastic buffer for the recovered incoming data, and an analogue phase-locked loop, whose feedback division ratio is modulated by a digitally filtered pointer error signal from the elastic buffer, to generate a low-jitter clock and a correspondingly retimed isochronous data-stream.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

1. A clock synchroniser for generating a local clock signal synchronised to a received clock signal, comprising:
a reference oscillator arranged to provide a reference signal having a reference frequency;
a synthesiser circuit arranged to generate a local clock signal from the reference signal;
an elastic buffer comprising data storage adapted to store data; and
a control link linking the elastic buffer to the synthesiser circuit,
wherein the synthesiser circuit comprises a phase-locked-loop circuit comprising
a controlled oscillator arranged to receive an oscillator control signal and to generate, at a controlled oscillator output, an oscillatory output signal having a frequency dependent on the oscillator control signal and which determines the local clock signal frequency,
a phase detector, having a first input arranged to receive the reference signal,
a feedback path from the controlled oscillator output to the phase detector and providing an oscillatory signal to a second input of the phase detector, the phase detector generating an output signal indicative of a phase difference between the reference signal at said first input and the oscillatory signal at said second input, and
an oscillator control signal generating circuit arranged to receive the output signal of the phase detector and to generate said oscillator control signal according to the phase detector output signal,
and wherein the elastic buffer has a data input for receiving data, a first clock input for receiving a received clock signal, a data output for outputting data, and a second clock input arranged to receive the local clock signal from the synthesiser circuit,
the elastic buffer being responsive to a received clock signal at the first clock input to clock data provided to the data input into the data storage, and being responsive to the local clock signal at the second clock input to clock data out of the data storage,
the elastic buffer being further adapted to output a digital fill-level signal indicative of the quantity of data stored in the data storage, and
the control link being arranged to receive the digital fill-level signal and to provide a frequency control signal to the phase-locked-loop circuit to control the frequency of the oscillatory output signal according to the digital fill-level signal so as to control the local clock frequency to maintain a desired average quantity of data in the data storage;
and wherein the phase-locked-loop circuit comprises a controllable divider arranged in said feedback path, the divider being arranged to receive the frequency control signal and being controlled by the frequency control signal to set a frequency division value N along said path to determine a ratio of the local clock frequency to the reference frequency.

2. A clock synchroniser in accordance with claim 1, wherein the control link comprises a digital filter arranged to filter the digital fill-level signal and produce a filtered output signal.

3. A clock synchroniser in accordance with claim 2, wherein the frequency control signal is the filtered output signal.

4. A clock synchroniser in accordance with claim 2, wherein the frequency control signal is derived from the filtered output signal.

5. A clock synchroniser in accordance with claim 1, wherein the reference oscillator comprises a crystal oscillator.

6. A clock synchroniser in accordance with claim 1, wherein the controlled oscillator is a voltage controlled oscillator.

7. A clock synchroniser in accordance with claim 1, wherein the phase detector is a digital phase detector, arranged to provide a digital phase signal dependent on a phase difference between the signals at its first and second inputs.

8. A clock synchroniser in accordance with claim 7, wherein the phase detector is a phase and frequency detector.

9. A clock synchroniser in accordance with claim 7, wherein the controlled oscillator is a voltage controlled oscillator, and the oscillator control signal generating circuit comprises a filter and a charge pump, the charge pump being controlled by the digital phase signal to supply current to the filter, the filter being arranged to integrate the supplied current to provide a control voltage to the voltage controlled oscillator as the oscillator control signal.

10. (canceled)

11. A clock synchroniser in accordance with claim 1, wherein the divider is a digitally controlled divider, and said frequency control signal is a digital control signal.

12. A clock synchroniser in accordance with claim 1, wherein the phase locked loop circuit is a fractional-N phase locked loop circuit, the divider being controllable to achieve a non-integer average value of N.

13. A clock synchroniser in accordance with claim 1, wherein the divider is arranged to divide the oscillatory output signal from the controlled oscillator and to provide the divided signal to the second input of the phase detector.

14. A clock synchroniser in accordance with claim 1, wherein the synthesiser circuit comprises at least one further divider arranged to divide the oscillatory output signal from the controlled oscillator to produce the local clock signal.

15. A clock synchroniser in accordance with claim 1, wherein the local clock signal is the oscillatory output signal from the controlled oscillator.

16. A clock synchroniser in accordance with claim 1, wherein said data storage comprises a storage array and the elastic buffer comprises an input counter adapted to record an input counter value, an output counter adapted to record an output counter value, and a comparator,
the elastic buffer being responsive to a clock pulse at the first clock input to increase the input counter value by a first increment, and the input counter being arranged to provide an input counter signal to the comparator, the input counter signal being indicative of the input counter value, and to provide an input pointer to the storage array,
the input pointer being dependent on the input counter value,
the elastic buffer being responsive to a clock pulse at the second clock input to increase the output counter value by a second increment, and the output counter being arranged to provide an output counter signal to the comparator, the output counter signal being indicative of the output counter value, and to provide an output pointer to the storage array, the output pointer being dependent on the output counter value,
the comparator being arranged to generate and output said digital fill-level signal according to the input and output counter signals,
and the arrangement being such that in response to a clock pulse at the first clock input data is clocked into the storage array to a location determined by the input pointer, and such that that in response to a clock pulse at the second clock input data is clocked out of the storage array from a location determined by the output pointer.

17. A clock synchroniser in accordance with claim 16, wherein the first increment and second increment have equal magnitudes.

18. A clock synchroniser in accordance with claim 16, further comprising increment control circuitry arranged to control the magnitude of the first increment.

19. A clock synchroniser in accordance with claim 18, wherein the increment control circuitry is arranged to control the magnitude of the second increment.

20. A clock synchroniser in accordance with claim 19, wherein the increment control circuitry is arranged to control the first and second increments such that they have a common magnitude, and is further arranged to reduce said common magnitude from a first value to a second value as the local clock signal is brought into synchrony with the received clock signal.

21. A clock synchroniser in accordance with claim 16, wherein said storage array has a depth defined by a first number of clock pulses, the input counter is adapted to store a maximum input counter value, the output counter is adapted to store a maximum output counter value, the maximum input and output counter values each being greater than said first number.

22. A clock synchroniser in accordance with claim 21, wherein each of the maximum input and output counter values is greater than said first number by at least one order of magnitude.

23. A clock synchroniser in accordance with claim 16, wherein said input counter value is recorded by the input counter as a word comprising a plurality of digits, and the input pointer is arranged so as to be independent of at least the most significant digit of said plurality of digits.

24. A clock synchroniser in accordance with claim 23, wherein the input pointer is provided by a plurality of the least significant digits of said word.

25. A clock synchroniser in accordance with claim 16, wherein said output counter value is recorded by the output counter as a second word comprising a second plurality of digits, and the output pointer is arranged so as to be independent of at least the most significant digit of said second plurality of digits.

26. A clock synchroniser in accordance with claim 25, wherein the output pointer is provided by a plurality of the least significant digits of said second word.

27. A clock synchroniser in accordance with claim 16, wherein the comparator is adapted to generate said fill-level signal by comparing the input and output counter signals to generate a number indicative of a difference between the counter values, and subtracting a predetermined number from said indicative number.

28. A clock synchroniser in accordance with claim 27, wherein said predetermined number corresponds at least approximately to half of the depth of the storage array.

29. A clock and data recovery circuit for recovering a clock signal and data from a data stream containing data and embedded clock information, the circuit comprising:
a data and clock extraction circuit having an input arranged to receive a data stream containing data and embedded clock information, the extraction circuit being arranged to generate and output an extracted clock signal according to the embedded clock information and to generate and output an extracted data signal according to the contained data; and
a clock synchroniser in accordance with any preceding claim,
wherein the extracted clock signal is provided to the first clock input as the received clock signal and the extracted data signal is provided to the data input.

30. A clock and data recovery circuit in accordance with claim 29, wherein the data and clock extraction circuit comprises a digital phase-locked loop circuit arranged to receive a further clock signal and the data stream, and to extract and output said extracted clock signal using the system clock.

31. A clock and data recovery circuit in accordance with claim 30, and comprising a reference oscillator arranged to provide the further clock signal to the digital phase-locked loop.

32. A clock and data recovery circuit in accordance with claim 29, wherein the data and clock extraction circuit comprises a digital phase-locked loop circuit comprising:
a numerically controlled oscillator arranged to generate an oscillatory signal at an output;
a phase detector, having a first input arranged to receive the data stream and a second input arranged to receive an oscillatory signal via a feedback path from said output of the numerically controlled oscillator, and being arranged to output a phase error signal indicative of a phase difference between the signals provided to its first and second inputs; and
a filter arranged to filter the phase error signal and provide an output signal to control the numerically controlled oscillator to determine a frequency of the oscillatory signal at the output of the numerically controlled oscillator.

33. A clock and data recovery circuit in accordance with claim 32, wherein the received clock signal is the oscillatory signal from said output of the numerically controlled oscillator.

34. A clock and data recovery circuit in accordance with claim 32, wherein the received clock signal is derived from the oscillatory signal at the output of the numerically controlled oscillator.

35. A clock synchroniser for generating a local clock signal synchronised to a received clock signal, comprising:
a reference oscillator arranged to provide a reference signal having a reference frequency;
a synthesiser circuit arranged to synthesise a local clock signal from the reference signal, the synthesiser circuit comprising a phase-locked-loop circuit including a phase detector, having a first input arranged to receive the reference signal, and a controllable divider arranged in a feedback path from a controlled oscillator to a second input of the phase detector, the divider being controllable to set a frequency division value N along said path to determine a ratio of the local clock frequency to the reference frequency;
a clock comparison circuit arranged to receive the local clock signal and a received clock signal, and adapted to generate a first digital signal indicative of an asynchronism between the local and remote clock signals; and
a control link linking the clock comparison circuit to the divider, the control link being arranged to receive the first digital signal and to provide a control signal to the divider to adjust the frequency division value N according to the first digital signal to alter the local clock frequency and reduce the asynchronism,
wherein the clock comparison circuit comprises an elastic buffer comprising data storage adapted to store data, and the elastic buffer having a data input for receiving data, a first clock input for receiving the received clock signal, a data output for outputting data, and a second clock input arranged to receive the local clock signal from the synthesiser circuit,
the elastic buffer being responsive to a received clock signal at the first clock input to clock data provided to the data input into the data storage, and being responsive to the local clock signal at the second clock input to clock data out of the data storage,
the elastic buffer being adapted to output said first digital signal, said first digital signal being a digital fill-level signal indicative of the quantity of data stored in the data storage,
and the control link being arranged to control the local clock frequency to maintain a desired average quantity of data in the data storage.

36. A clock synchroniser in accordance with claim 35, wherein said data storage comprises a storage array and the elastic buffer comprises an input counter adapted to record an input counter value, an output counter adapted to record an output counter value, and a comparator,
the elastic buffer being responsive to a clock pulse at the first clock input to increase the input counter value by a first increment, and the input counter being arranged to provide an input counter signal to the comparator, the input counter signal being indicative of the input counter value, and to provide an input pointer to the storage array, the input pointer being dependent on the input counter value,
the elastic buffer being responsive to a clock pulse at the second clock input to increase the output counter value by a second increment, and the output counter being arranged to provide an output counter signal to the comparator, the output counter signal being indicative of the output counter value, and to provide an output pointer to the storage array, the output pointer being dependent on the output counter value,
the comparator being arranged to generate and output said digital fill-level signal according to the input and output counter signals,
and the arrangement being such that in response to a clock pulse at the first clock input data is clocked into the storage array to a location determined by the input pointer, and such that that in response to a clock pulse at the second clock input data is clocked out of the storage array from a location determined by the output pointer.

37. A method of generating a local clock signal synchronised to a received clock signal, comprising the steps of:
generating a reference signal having a reference frequency;
synthesising a local clock signal from the reference signal using a phase-locked loop circuit;
providing a received clock signal to a first clock input of an elastic buffer comprising data storage adapted to store data;
providing data to a data input of the elastic buffer;
providing the local clock signal to a second clock input of the elastic buffer, the elastic buffer having a data output for outputting data and being responsive to the received clock signal at the first clock input to clock data provided to the data input into the data storage, and being responsive to the local clock signal at the second clock input to clock data out of the data storage;
generating and outputting from the elastic buffer a digital fill-level signal indicative of the quantity of data stored in the data storage; and
using the digital fill-level signal to control the phase-locked-loop circuit to control the local clock frequency to maintain a desired average quantity of data in the data storage by setting a frequency division value N along a feedback path of the phase-locked-loop in order to determine a ratio of the local clock frequency to the reference frequency.

38. A method in accordance with claim 37, further comprising the step of filtering the digital fill-level signal with a digital filter and using the filtered digital fill-level signal to control the phase-locked-loop circuit.

39. A method in accordance with claim 38, wherein the phase-locked-loop circuit comprises a controllable divider, arranged in a feedback path from a controlled oscillator to a phase detector and controllable to set the frequency division value N along said path to determine a ratio of the local clock frequency to the reference frequency.

40. A method in accordance with claim 38, wherein said data storage comprises a storage array and the elastic buffer comprises an input counter adapted to record an input counter value, an output counter adapted to record an output counter value, and a comparator, the method further comprising the steps of responding to a clock pulse at the first clock input by increasing the input counter value by a first increment, providing an input counter signal to the comparator from the input counter, the input counter signal being indicative of the input counter value, providing an input pointer to the storage array, the input pointer being dependent on the input counter value,
responding to a clock pulse at the second clock input by increasing the output counter value by a second increment, providing an output counter signal to the comparator from the output counter, the output counter signal being indicative of the output counter value, providing an output pointer to the storage array, the output pointer being dependent on the output counter value,
using the comparator to generate and output said digital fill-level signal according to the input and output counter signals,
responding to a clock pulse at the first clock input by clocking data into the storage array to a location determined by the input pointer, and in responding to a clock pulse at the second clock input by clocking data out of the storage array from a location determined by the output pointer.

41. A method in accordance with claim 40, further comprising the step of controlling the magnitude of at least one of the first and second increments.

42. A method in accordance with claim 41, comprising the step of adjusting the magnitudes of the first and second increments as the local clock signal is brought into synchronisation with the received clock signal.

43. A method in accordance with claim 41, comprising the steps of controlling the first and second increments such that they have a common magnitude, and reducing said common magnitude from a first value to a second value as the local clock signal is brought into synchrony with the received clock signal.

44. A method in accordance with claim 41, comprising the steps of recording said input counter value as a word comprising a plurality of digits, and using only a least significant part of said word as the input pointer.

46. A method in accordance with claim 41, wherein the step of using the comparator to generate said fill-level comprises comparing the input and output counter signals to generate a number indicative of a difference between the counter values, and subtracting a predetermined number from said indicative number.

47. A clock synchroniser in accordance with claim 1 wherein the control link further comprises a delta sigma modulator.

48. A clock synchroniser in accordance with claim 35 wherein the control link further comprises a delta sigma modulator.

49. A method in accordance with claim 37 further comprising delta sigma modulating the digital fill-level signal.
